(19) United States
(12) Patent Application Publication
(10) Pub. No.: US 2011/0224954 A1
(43) Pub. Date: Sep. 15, 2011

(54) MODELLING OF SYSTEMS

(75) Inventors: Chandika Dimuthu Bandara Jayasundara, Colombo (LK); Nicholas Mark Hamilton Foster, Victoria (AU); Charanjit Singh, Singapore (SG)

(73) Assignee: CINERGIX PTY LTD, Carlton, Victoria (AU)

(21) Appl. No.: 13/060,259

(22) PCT Filed: Aug. 17, 2009
(86) PCT No.: PCT/AU09/01052

§ 371 Date: May 19, 2011

(30) Foreign Application Priority Data
Aug. 26, 2008 (AU) 2008904397

(51) Int. Cl. G06F 17/50; G06F 19/00

(52) U.S. Cl. 703/1

(57) ABSTRACT

A method of modelling a system, the method comprising: receiving via an interface input to create or load a model of the system; receiving via the interface further input in relation to the system model; determining whether the further input results in a change to the system model; and if the further input is determined to change the system model, automatically providing feedback via the interface, the feedback being in relation to the changed system model.

### TECHNICAL FIELD

The described embodiments relate generally to methods, systems and stored program code for enabling modelling of systems.

### BACKGROUND

Designing complex systems can be a difficult and time-consuming task. This is particularly so where the systems have many parts or components that interact with different parts and components in different ways. In such complex systems, a change to one part of the system can affect other parts of the system.

Examples of systems that require a well-considered design include computer networks, electronic circuits, business processes, buildings and industrial facilities or natural/environmental systems. Often, design of a system requires expert knowledge to know which components work together, how a system fits its environment and what inputs and outputs are expected of the system. For a complex system like a computer data center, the design process can take months.

As part of creating a new system, a conceptual model of the system may be created. However, such conceptual models have substantial limitations where changes to components, inputs or outputs are required.

It is desired to address or ameliorate one or more shortcomings or disadvantages associated with existing modelling techniques and systems, or at least to provide a useful alternative thereto.

### SUMMARY

Some of the described embodiments relate to a method of modelling a system. The method comprises:
receiving via an interface input to create or load a model of the system;
receiving via the interface further input in relation to the system model;
determining whether the further input results in a change to the system model; and
automatically providing feedback via the interface in relation to the changed system model if the further input is determined to change the system model.

The system model may comprise at least one object model representing a component of the system, wherein the at least one object model comprises a plurality of properties, including at least one data item, at least one connection port and at least one behaviour. The at least one behaviour may comprise at least one of a rule and a function.

The method may also involve automatically validating the changed system model. The validating may comprise determining whether the change to the system model causes a problem within the system model and providing an indication of the problem via the interface if the change is determined to cause a problem. Determining whether the change causes a problem may comprise determining whether the change results in inconsistencies among properties of the at least one object model. The validating may comprise:
determining at least one data item and at least one behaviour affected by the change; and
executing each rule or function of the at least one behaviour in relation to a respective one of the at least one data item.

The validating may further comprise:
determining whether at least one dependant data item of the at least one object model is affected by the change, each at least one dependant item being dependant on one of the at least one data item;
determining at least one behaviour that references the at least one dependant data item; and
executing each rule or function of the at least one behaviour that references the at least one dependant data item.

The system model may further comprise at least one connector model, each connector model representing a connection between two object models.

The interface may comprise a diagram editor application and a diagram of the system model may be displayed in a window of the diagram editor application. The method may comprise displaying a diagram of the system model and the diagram may comprise graphical representations of any object models and connector models comprised in the system model. The method may further comprise: determining whether graphical representations of object models of compatible types are sufficiently graphically proximate within the diagram to establish a connection between the object models; determining whether the connection can be established between the object models based on properties of each of the object models; and establishing the connection if it is determined that the connection can be established. A connector model may be added to the system model in response to the connection being established.

Some embodiments relate to a method of enabling modelling of a system, wherein the method involves receiving a serve request at a server system, authenticating the serve request and transmitting program code to the originator of the serve request, the program code being executable by a processing system to cause the processing system to perform any of the modelling methods described above. The method of enabling may also comprise receiving a save request from the originator of the serve request, the save request being in respect of a new or revised system model, and storing the system model in data storage accessible to the server system in response to the save request. The transmitting may be performed using a cryptographically secure transmission protocol.

Further embodiments relate to a modelling system for modelling a system, the modelling system comprising an interface, at least one processing device in communication with and/or executing the interface and stored program code accessible to the processing device. The stored program code, when executed by the processing device, causes the processing device to perform any of the methods of modelling described above.

Further embodiments relate to server systems for enabling modelling of a system, the server systems comprising at least one processor and data storage accessible to the at least one processor. Program code is stored in the data storage such that, when the program code is executed by the at least one processor, the at least one processor is caused to perform the method of enabling modelling described above.

Further embodiments relate to computer readable storage media storing program code which, when executed by at least one processing device, causes the at least one processing device to perform any of the methods described above.

### BRIEF DESCRIPTION OF THE DRAWINGS

Embodiments are described in further detail below, by way of example, with reference to the accompanying drawings, in which:

FIG. 1 is a block diagram of a client-server system;

FIG. 2 is a block diagram showing the client system in further detail;

FIG. 3 is a block diagram showing a validation module and a central data model;

FIG. 4 is a block diagram of a knowledge object definition;

FIG. 5 is a block diagram of a general example of a knowledge object model;

FIG. 6 is a block diagram of a more specific example of a knowledge object model;

FIG. 7 is a block diagram illustrating a connection between two knowledge object models;

FIG. 8 is a block diagram of an example connector model;

FIG. 9 is an example screen shot of a diagram editor application window;

FIG. 10 is a flowchart of a method of enabling modelling of a system;

FIG. 11 is a flowchart illustrating execution of a modelling method;

FIG. 12 is a flowchart of a method of creating a model;

FIG. 13 is a flowchart of a method of creating an instance of a knowledge object of the model;

FIG. 14 is a flowchart of a method of creating a connection between two knowledge objects;

FIG. 15 is a flowchart of a method of automatically validating a model after a change to the model;

FIG. 16 is a flowchart of a method of executing a function as part of the validation process; and

FIG. 17 is a flowchart of a method of executing a rule as part of a validation process.

### DETAILED DESCRIPTION

Some of the described embodiments are intended for general use in relation to visual modelling software or computer-aided design (CAD) software to define a self-validating model of a system. In this context, a model of a system is made up of interconnected objects. Each object may in turn behave as a system, receiving inputs, processing the input data with internal calculations and logic and then producing outputs.

Each object, referred to herein generally as a knowledge object (KO or KObject) because of its information-rich nature, has a set of data items, or at least one data item, that records the state and properties of the object. An object also has internal rules and/or functions that update its own data items, depending on various events, such as data items of other objects being updated. Some of the outputs of an object may be in the form of visual or auditory feedback, while the rest of the outputs may be data outputs directed to other knowledge objects.

The knowledge objects are linked with each other through connections. Generally, an output from one knowledge object links to an input of another knowledge object. An input may trigger changes to internal data properties of a knowledge object, which in turn may trigger logic rules or functions that may cause other internal data items to be updated. A knowledge object may contain internal logic rules that trigger display of messages (warnings, errors, suggestions, status updates) to the user, depending on data item values.

In the context of the described embodiments, knowledge objects are the building blocks for developing a system model, where each knowledge object contains information regarding the nature, content and functions of the object which it is intended to represent, as well as information specifying inputs and/or outputs to other knowledge objects. The systems and methods described herein cause the system model to self-validate on any change to a property of any knowledge object or any connection between knowledge objects, thereby allowing a system designer ready identification of any problems or consequences of a change to any one part or configuration of the system.

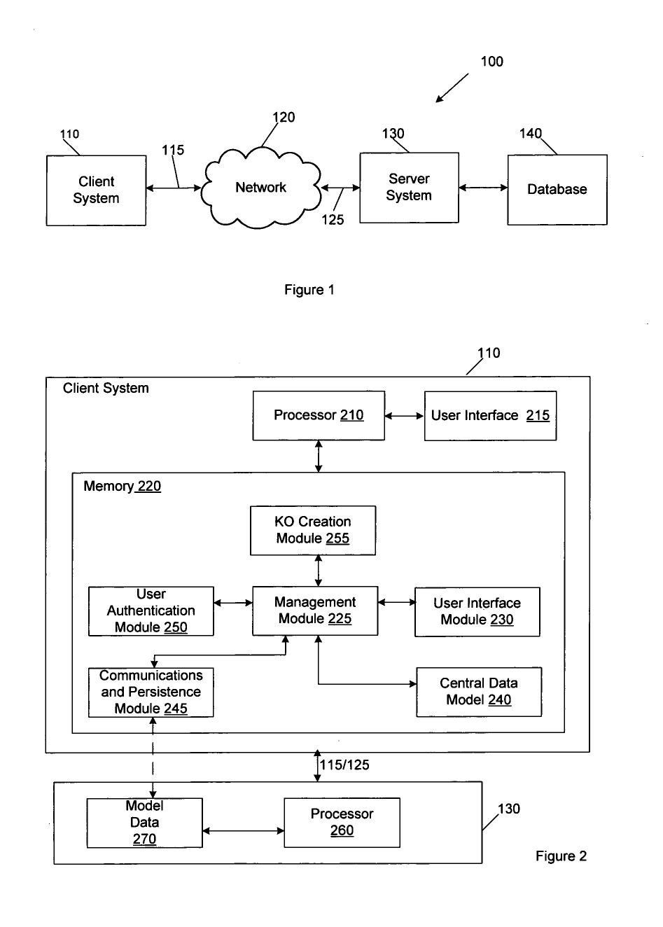

Referring now to FIG. 1, a client-server system architecture 100 is described in further detail, in which some of the described embodiments may be performed. System architecture 100 comprises a client system 110, a server system 130 and a database 140 accessible to server system 130. Client system 110 and server system 130 are in communication over a network 120 via network connections 115 and 125.

Development of a system model according to the described embodiments is generally performed on client system 110, although the program code for enabling the creation and development of the system model may be provided to client system 110 by server system 130. When a user of client system 110 wishes to work on developing or adjusting a system model, the user operates a user interface 215 (FIG. 2) of client system 110 to cause client system 110 to navigate to an interface of server system 130, for example by using a browser application executing on client system 110 to transmit a serve request to a URL hosted by server system 130. If the user successfully completes an authentication process (or an initial registration process), server system 130 downloads program code to client system 110 over network 120 and network connections 115, 125 using a secure communications protocol. The program code thus downloaded to client system 110 comprises application software to enable creation or adjustment of a system model. An example of such program code is described below in relation to FIG. 2.

Database 140 may be used to store the program code that enables creation or adjustment of a system model and to store user account information to enable authentication of users, as well as system models and/or knowledge objects developed and stored by each registered user.

Referring now to FIG. 2, client system 110 is described in further detail. Client system 110 comprises a processor 210, user interface 215 and memory 220. Memory 220 is accessible to processor 210 and stores program code for executing and/or supporting functions of: a management module 225, a user interface module 230, a central data model 240, a communications and persistence model 245, a user authentication module 250 and a model creation module 255.

Processor 210 communicates with user interface 215 and executes user interface module 230 to provide user interface functionality. User interface 215 may comprise computer peripheral devices, such as a display, a printing device and/or other output devices, and one or more input devices, such as a keyboard, mouse, stylus, touch screen or other input device. User interface 215 may also comprise suitable software, such as a browser application for example, to facilitate the user's interaction with a part of system 100.

Processor 210 may comprise a single processing device or multiple processing devices, either within a single computing system or distributed across multiple computing systems comprised in client system 110. Memory 220 may be partly or wholly physically located within or associated with client system 110 or may be partly or wholly associated with or distributed across multiple computing systems within client system 110 that may be physically distinct from computing systems in which processor 210 is partly or wholly located. Memory 220 may comprise different forms of computer readable storage, at least some of which comprises a volatile store for temporarily storing program code and other data, including the program code modules described herein. Memory 220 may also comprise other program code modules for performing standard computing functions, such as operating system software, peripheral device drivers, etc. Client system 110 may comprise a personal computer system, such as a laptop, desktop or handheld computing device, or may comprise a server system, for example.

Management module 225 performs general control, management and supervisory functions in relation to functions performed by the remaining modules, including central data model 240. Thus, management module 225 makes function calls to other modules, as appropriate, receives the responses to such function calls, and executes further function calls as necessary.

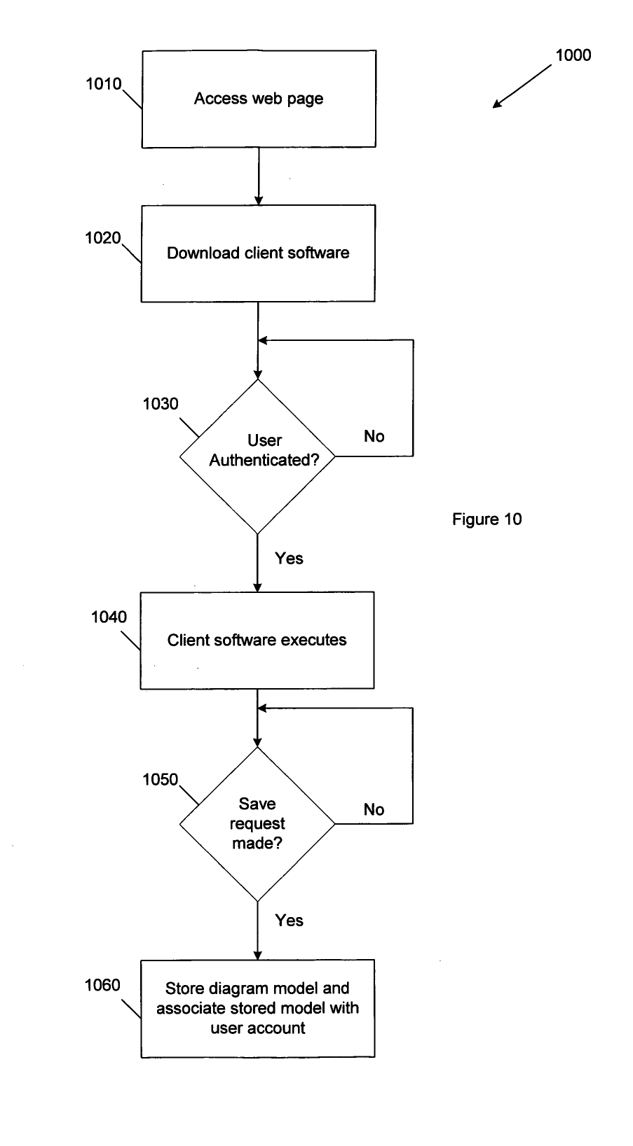

User interface module 230 is responsive to management module 225 to provide a display (such as is illustrated in the example screenshot shown in FIG. 10) via a display device within user interface 215. User interface module 230 is further configured to receive and parse instructions from processor 210 relating to input received via user interface 215, and then provide the parsed input to management module 225 for appropriate action. User interface module 230 may also act on the received input without further instruction from management module 225, for example where a graphical representation of an object in a modelled system is caused by user input to be graphically repositioned within an application window, user interface module 230 may be responsive to the repositioning input to move the graphical representation on the display according to the input.

Communication and persistence module 245 is responsible for maintaining communication with server system 130 via network connections 115, 125 and is also responsible for handling save requests to save a created or updated system model within model data 270 accessible to server system 130. Communications and persistence module 245 is also responsible for loading pre-existing model data from the server upon user request (for authenticated users). Communications and persistence module 245 may communicate with server system 130 using a cryptographically secure communications protocol. However, where network 120 is a suitably secure private network, communications and persistence module 245 may employ a suitable non-encrypted communications protocol.

User authentication module 250 performs user authentication functions, including receiving the input of a user ID and password pair that is communicated in a secure manner to the server system 130 via the communications and persistence module 245 (via the management module 225). The server system 130 authenticates the received user credentials against the records stored in the database 140 and returns a message indicating the result of the authentication of the credentials provided by the user. Upon successful user authentication, the server system 130 allows the user to download existing system models stored in the database 140, for example such as models created at an earlier time by the same authenticated user. User authentication module 250 communicates with user interface module 230 via management module 225 to accomplish its user input aspects of the authentication functions, such as inviting and receiving input of a user ID and password.

Model creation module 255 is responsible for creation of a knowledge object instance, including its intended data structures, behaviours and ports, based on input received via user interface module 230 and based on knowledge object definitions contained in central data model 240.

As shown in FIG. 2, server system 130 comprises processor 260 and model data 270. Processor 260 may comprise a single processing device or multiple processing devices, either within a single computing system in server system 130 or distributed across multiple such computing systems. Processor 260 has access to model data 270. Although not shown for simplicity of illustration, server system 130 may comprise a normal server architecture, including for example an operating system, a HTTP daemon, ASP or PHP support and database querying support. Model data 270 comprises system model data which may be uploaded to or downloaded from client system 110 and may be associated with a user account. Model data 270 may be stored within a memory (not shown) of server system 130 or within a separate database, such as database 140.

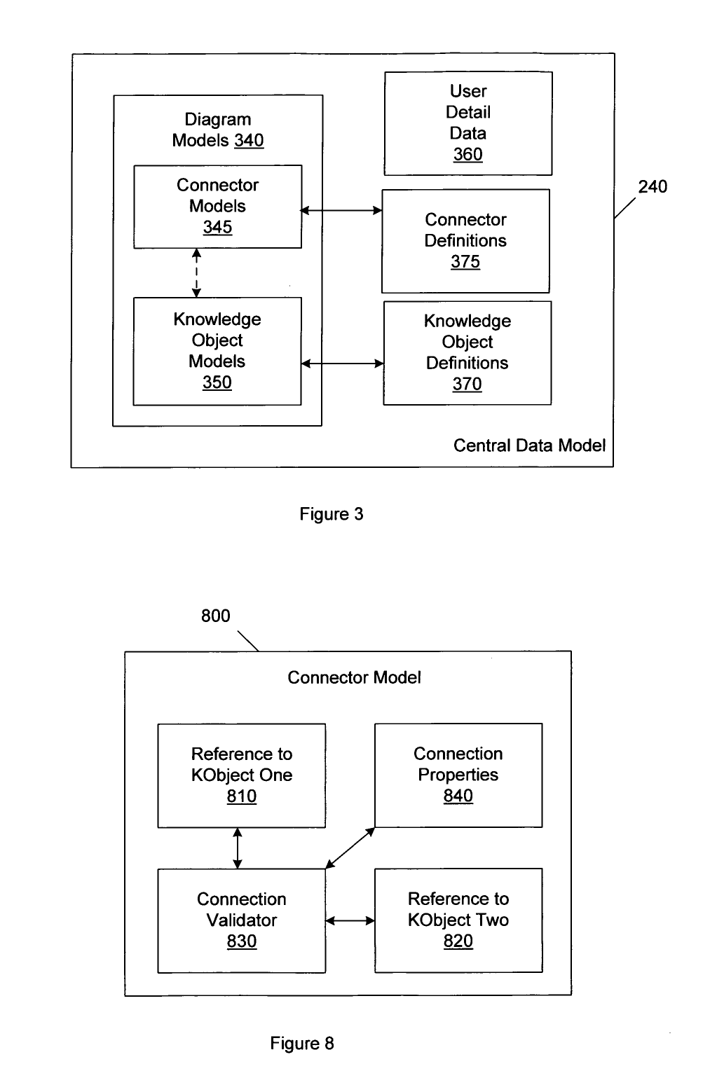

Referring now to FIG. 3, validation module 235 and central data module 240 are described in further detail. The central data model 240 retains a list of all the diagram models 310 which are currently active in the modelling system, current user identification reference 360 and a comprehensive list of the knowledge object definitions 370. The central data model 240 acts as the virtual storage module for all modelling data. The KO creation module 255, the user interface module 230 and the user authentication module 250 retrieve and store data by accessing the central data model 240 via the management module 225 for their relevant requests. Diagram models 340 contain data values in their relevant data structures for the system model diagrams that are loaded on to the client system 110. Each diagram model 340 comprises at least one knowledge object model 350 and zero or more connector models 345 that represent interconnections between knowledge objects in the diagram model 340 of the modelled system. The central data model 240 also contains at least one knowledge object definition 370 and zero or more connector definitions 375 to be used when instantiating a KObject connector.

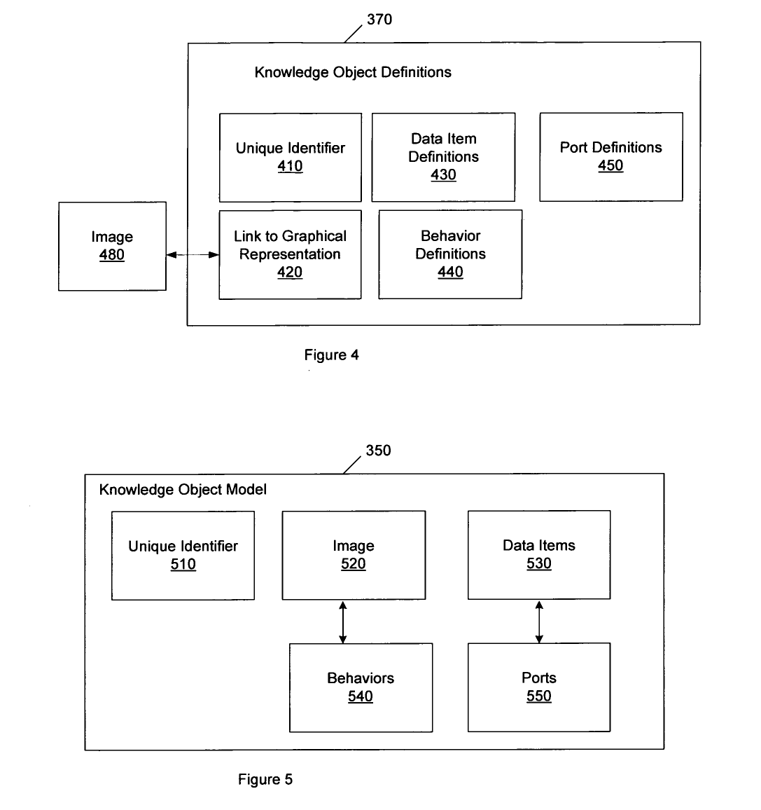

Referring now to FIG. 4, knowledge object definitions 370 are shown and described in further detail. Each knowledge object definition 370 may be recorded as a text based document, such as a document that is defined using the Extensible Mark-up Language (XML). A single KObject definition 370 contains a unique identifier 410, a uniform resource locator link 420 to a graphical representation of that KObject, a collection of one or more data item definitions 430, a collection of zero or more behaviour definitions 440 and a collection of zero or more port definitions 450. The link 420 to the graphical representation refers to an external image file accessible via the network 120.

A single data item definition 430 contains a unique name for that data item (but only unique within the scope of the knowledge object it belongs to) and the type of the data item, such as a number, a text value or a logic value (true/false).

A single behaviour definition 440 can either be a logical behaviour or a mathematical function. If it is a logical behaviour, it will have the logic statement containing the data items and literal values to compare and one or more logical comparison operators. The behaviour definition also specifies exact actions to execute if the logical condition evaluates to true. Such actions can be one or more of the following: change the value of a data item belonging to the current knowledge object; change a visual property of the current knowledge object; and execute another nested logic behaviour, which in turn may have its own success scenario actions. If the behaviour is a mathematical function, it will include the mathematical expression that will include data item names (among other literals) as variables of the expression and a pointer or indication of the data items to update with the results of the evaluated mathematical expression.

A port definition 450 includes the type of port, differentiated by input, output or input/output and a compatibility identifier name. The compatibility identifier is used when creating a connector model 800 by the connection validator 830 to match two ports for interconnection. If a port is an output port or an input/output port, the port definition 450 will have at least one reference to a data item that is to be transmitted out of the port when the data item values of that data item is updated. If the port is of type input or input/output, the port definition 450 will contain at least one data item that will be updated by incoming data item values through the connection linked to the port.

Referring now to FIG. 5, an example of a basic knowledge object model 350 is shown and described in further detail. The knowledge object model 350 contains a unique identifier 510 (but only unique in the scope of the diagram the KObject belongs to) that is derived from unique identifier 410 of the KO definitions 370 used to create the KO model 350, an image 520 which is the graphical representation of the knowledge object that will be displayed using the user interface module 230, at least one data item 530, zero or more ports 550, and zero or more behaviours 540.

A data item 530 comprise a unique identifier and a data value. This data value may be updated via user input that is received via the user interface 215, through execution of behaviours or by updates that are received through incoming data values for ports.

A behaviour 540 is implemented according to the behaviour definition 440 described above. In one specific implementation, the generic behaviour definition 440 is populated with explicit references to the data items that belong to the current knowledge object to create each behaviour 540. A behaviour 540 may update a data item or a visual property of the image 520, for example depending on whether the behaviour specifies such actions.

A port 550 will also be replicated according to the port definition 450 of the relevant knowledge object definition 370, and is populated with explicit references to the data items 530 of the current knowledge object. The port 550 may transmit updates to data items 530 and may also update the values contained within the data items 530 upon receiving input.

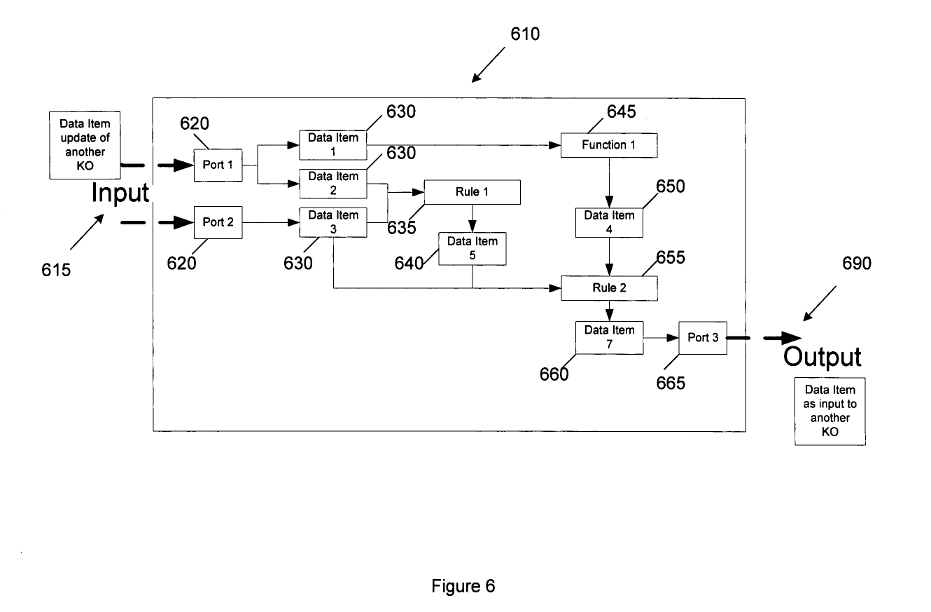

Referring now to FIG. 6, a further example of a knowledge object model 610 (of greater complexity than the knowledge object model described in relation to FIG. 5) is shown and described in further detail. When a knowledge object is connected to another knowledge object, their connection is defined through the use of input ports 620 and output ports 665. The knowledge object 610 receives input 615 at input ports 620. The input 615 received may be stored in previously defined data items, 630. Each data item 630 can be connected to a behaviour, such as a first rule 635 or function 645, which may be defined to produce outputs to other data items from the inputs. The output of a rule or function may be placed into further data items 640 and 650, or into the same data item that acted as the input to the rule or function. The data items and rules and functions can be linked to form chained behaviours, such as is exemplified by a second rule 655 into which multiple data items 630, 640 and 650 are input. This second rule 655 may then provide its output to a further data item 660. Data items, such as data item 660, may be connected to output port 665. The output port 665 produces the knowledge object output 690 which may act as an input 615 to another knowledge object via its input ports.

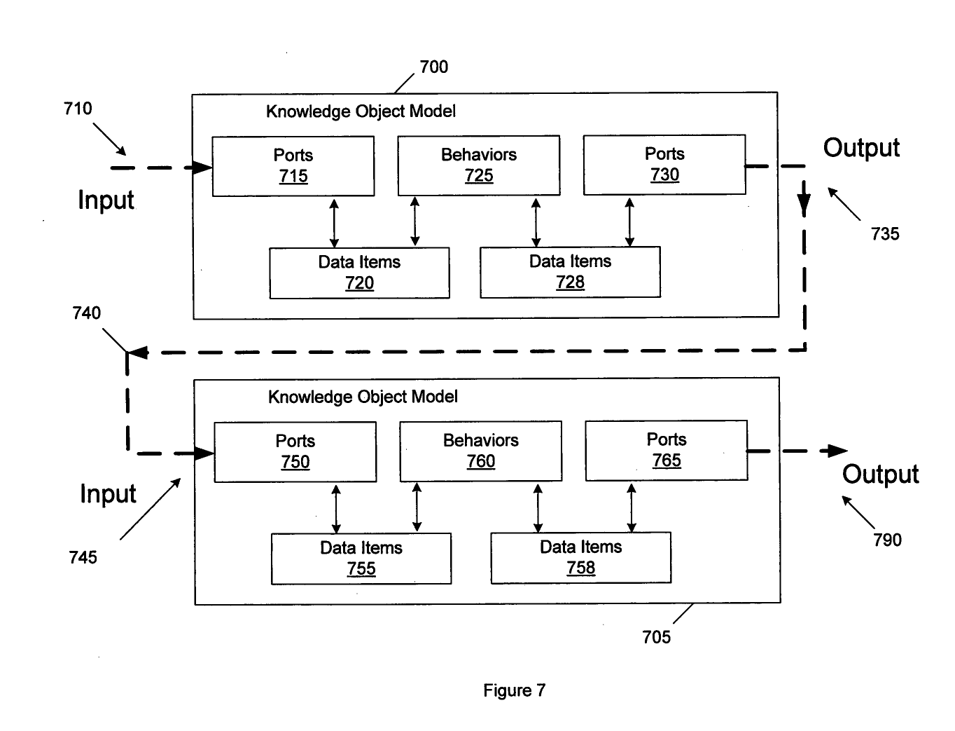

Referring now to FIG. 7, an example of several knowledge objects connected together is described. Knowledge objects can be connected in a manner to allow the input from one knowledge object to be connected to the output of another knowledge object. The example in FIG. 7 shows two knowledge objects 700 and 705. Knowledge object 700 receives input at 710 through the input ports 715, which allows data item values to be stored in data items 720. The stored data item values may be operated on by behaviours 725 and are stored back into data items 728. Output ports 730 coupled to receive output from data items 728 or 720 can then provide output 735 from the knowledge object 700.

The output 735 from ports 730 can be connected as the input 745 to knowledge object 705. The connection between knowledge object 700 and knowledge object 705 is made via connector 740 and allows the output 735 of knowledge object 700 to be connected to the input 745 of knowledge object 705. The input 745 is received by the input ports 750, which allows data item values to be stored in data items 755. The data item values may be operated on by behaviours 760 and stored back into data items 758. Output ports 765 coupled to receive output from data items 758 or 755 can then provide output 790 from the knowledge object 705. The output 790 can act as the input to another knowledge object using a similar connector mechanism to that previously described.

Referring now to FIG. 8, an example connector model 800 is shown and described. Connector model 800 serves the purpose of connecting two knowledge objects via ports on each knowledge object. The connector model 800 comprises references 810, 820 to the two KObjects it is interconnecting, a set of connection properties 840 defining a connection type that needs to be matched by at least one port each from the KObjects the connector model is referring to, and a connection validator 830 that evaluates the compatibility of the two knowledge object against the connection properties.

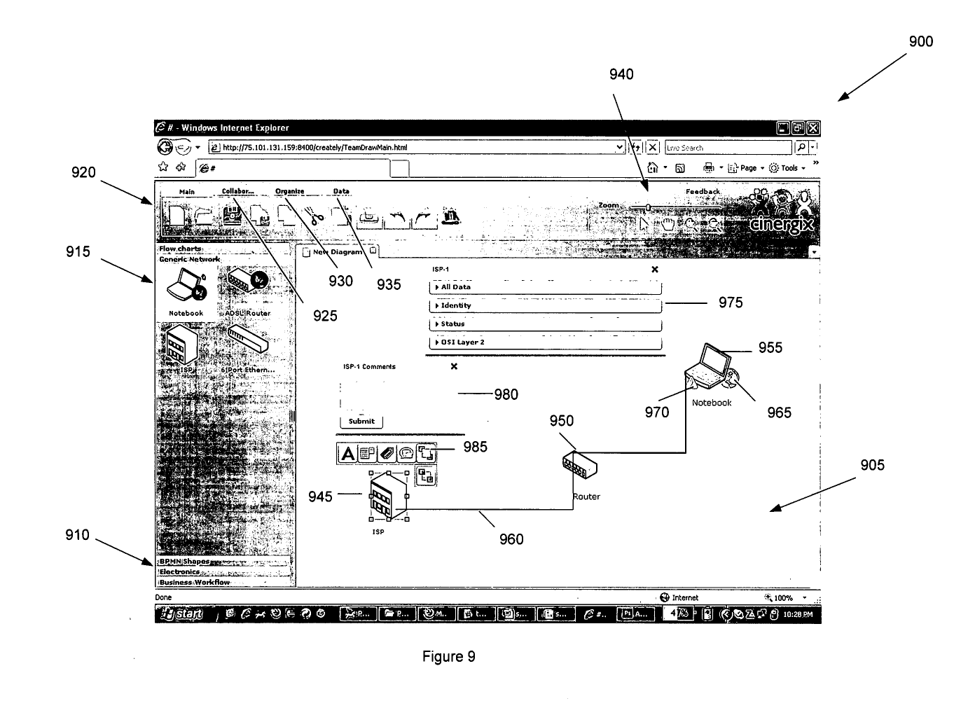

Referring now to FIG. 9, an example screen image 900 of a diagram editing/creation application window generated by user interface module 230 for display via user interface 215 is shown and described in further detail. Image 900 is a screen capture showing an example display generated using the modelling system 100. The application window provides an application work area that comprises distinct sections. One section provides a viewport 905 displaying the system model that is being developed or worked upon. The viewport 905 allows the user to place knowledge objects on to it which are chosen from a KObject library shown in section 910. The library can contain a number of groups of pre-existing KObjects, grouped according to type or function, etc. In the example shown in FIG. 9, the group of ‘Generic Network’ is shown and this is indicated by reference numeral 915.

Image 900 also illustrates a menu and function area 920. The menu and function area 920 can contain a number of menu and/or function tabs 925, 930, 935. The active tab shown in section 920 is a “main” function tab that controls the application functions most used by the user, including functions relating to starting new models, saving models and loading models, for example. In order to expose collaboration functionality to the user, menu 925 is presented, which provides publishing and sharing options. To produce complicated models, ordering and layering is required and this is available through tab 930. The data that underlies the models can be exported through the commands behind tab 935. If the user is creating large or complex models, the user may choose to operate a control 940 to vary the zoom level of the viewport 905.

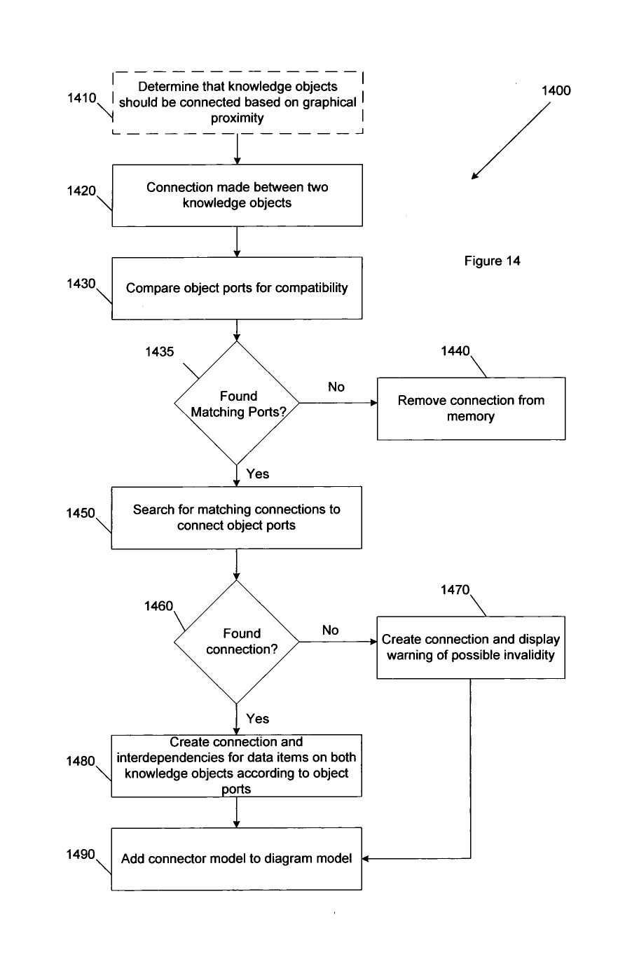

In the example screen image 900, an example network diagram is modelled and is visible in the viewport 905. The illustrated system model is made up of components including an interne service provider (ISP) 945, a router 950 and a notebook computer 955. These can be taken by the user from the library 910 and the group 915, for example by dragging and dropping selected icons. When a component icon such as 945 is selected, a bounding box is displayed to show to the user that it is selected and a context-specific toolbar 985 is displayed above the component icon. The toolbar 985 comprises a number of option icons and may display unrelated options horizontally and related options vertically. The toolbar 985 provides options to allow the components to be linked with graphical representations 960 of connections, for example. For each such graphical representation 960, a connector model 800 is created according to method 1400 described below in relation to FIG. 14.

As a system model is built, the behaviours that have been incorporated into knowledge objects making up the model are checked and evaluated to produce feedback such as that shown by indicators 965 and 970. Indicator 965 resembles a globe and provides an example of visual feedback about a status of the notebook computer 955, such as being connected to the Internet. Indicator 970 resembles a warning sign and provides an example of idea or fault feedback. Feedback such as indicator 965 is created by execution of rule behaviours such as are described below in relation to method 1700 and FIG. 17. Display of feedback may arise from a visual display update action such as at step 1760. The globe icon 965 is generated from image 520 which is manipulated by a display action such as at step 1760. Feedback such as indicator 970 is generated by execution of a rule behaviour as part of method 1700 and displayed as a result of a message display action such as at step 1770.

Visual feedback indicators may be specific to each knowledge object model 350 and defined by the behaviour definition 440 of the knowledge object definition 370 used to build the knowledge object model 350. The visual feedback indicators are provided to assist the user in creating valid models. The indicators may provide visual feedback on changes to data items of the knowledge object that affect its validity and effectiveness.

Feedback may be categorised as belonging to one of two types: graphical display manipulations and messages. The graphical display manipulations may involve changing colour, size or orientation of a KObject icon or showing, hiding or fading a part of the KObject icon.

The data for each component may be shown in a pop-up data window 975, in response to selection of an icon on a toolbar 985. Data window 975 allows the underlying data for the system model to be altered by the user. When a change is made to any aspect of the system model, the system will evaluate the change to produce further feedback for the user of the application, through feedback indicators such as indicators 965 and 970 or via a pop-up notification, for example. Additionally, the user is able to leave comments about a component within the model through a comments box 980 for that component. When using the collaboration functionality provided by menu 925, the collaborating users may record comments using comment boxes 980.

Referring now to FIG. 10, a method 1000 of enabling modelling of a system is described in further detail. Method 1000 begins at step 1010, at which client system 110 is caused by a user to access a specific web page (or IP address) made available by server system 130 over network 120. In response to the web page being accessed at step 1020, server system 130 may automatically download to client system 110 over network 120 client software for installation and execution on client system 110. This client software includes the program code modules to be stored in memory 220, as described above in relation to FIG. 2. The software downloaded at step 1020 may be encrypted so that, unless client system 110 is authenticated for use of the software, the software is un-useable by client system 110.

At step 1030, server system 130 requests that client system 110 authenticate itself for authorised use of the downloaded software. If the user authentication is successful at step 1030, then at step 1040, the downloaded client software is allowed to execute, for example by provision of a decryption code or other information from server system 130 to enable the partial or full decryption of the downloaded software.

If the user is not authenticated at step 1030, the encrypted client software will remain in client system 110 as useless encrypted data for as long as client system 110 allows that data to remain.

In alternative embodiments, the order of steps 1020 and 1030 may be reversed, so that the client software is only provided to client system 110 after user authentication is successfully completed.

Server system 130 awaits receipt of a save request from client system 110 at step 1050 and, if such a request is received, server system 130 then stores at step 1060 a system model that is the subject of the save request and associates the stored diagram model with an account established for the user. The save request comprises information to identify the user and information specifying the system model (including all object models and connector models within the system model) to be saved. The save request is generated by client system 110 in response to a user command and sent using communications and persistence module 245.

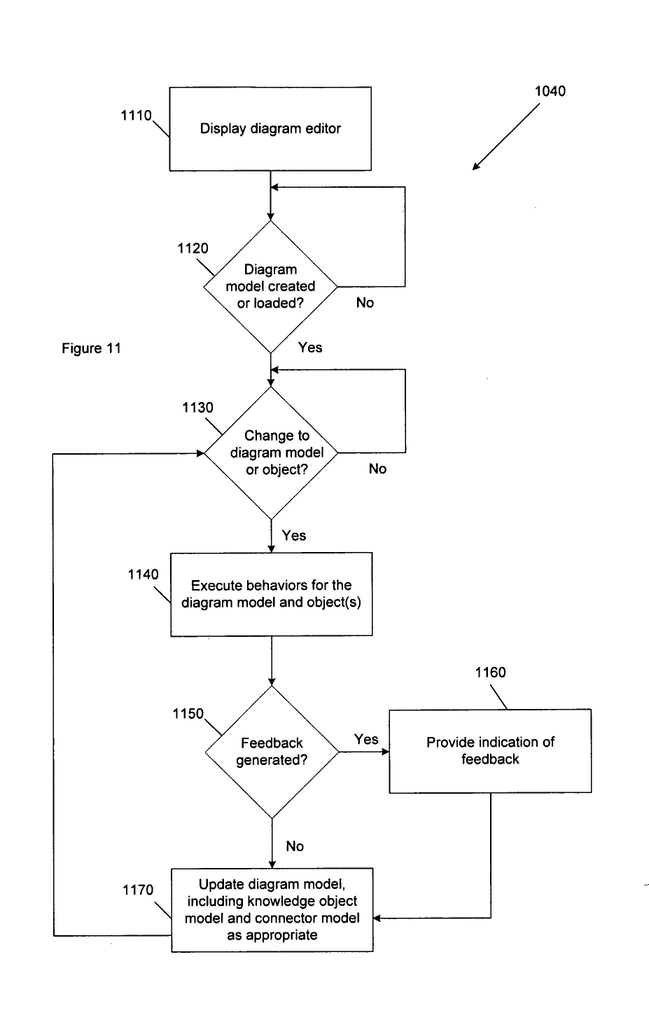

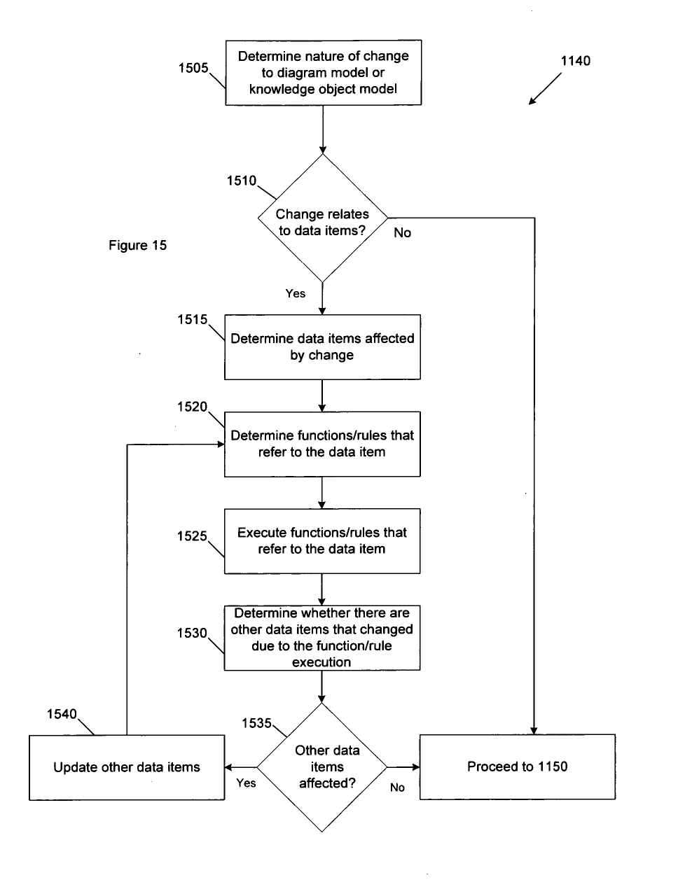

Referring now to FIG. 11, step 1040 is described in further detail, as executed according to the client software downloaded to client system 110. A process according to step 1040 begins at step 1110, at which a diagram editor application (provided by user interface module 230) is executed on client system 110 and a diagram editor application window, such as is shown in screen image 900, displayed via user interface 215. If a diagram model is created or loaded at step 1120, for example using the diagram editor application (and supported by model creation module 255) to create a new model or downloading a previously saved system model from server system 130, user interface module 230 and management module 225 determine at step 1130 whether a change is made to the diagram model or to an object within the model. If a change is determined at step 1130 to have occurred, then at step 1140, relevant behaviours 540 within each KObject of the model are executed. Step 1140 is described in further detail below, with reference to FIG. 15.

If at step 1150 it is determined that the behaviour executions at step 1140 have generated feedback for the user, such as a validation error or an information message, then an indication (such as one or more graphical indicators displayed in viewport 905) of the feedback is provided at step 1160 via user interface module 230 and user interface 215.

Whether or not feedback was generated at 1150 and an indication of the feedback provided at 1160, the diagram model is updated at step 1170 to reflect the change determined at step 1130. The update of the system model includes updating relevant knowledge object models and connector models as appropriate, including any changes to graphical separations of representations of the knowledge object models visible through viewport 905.

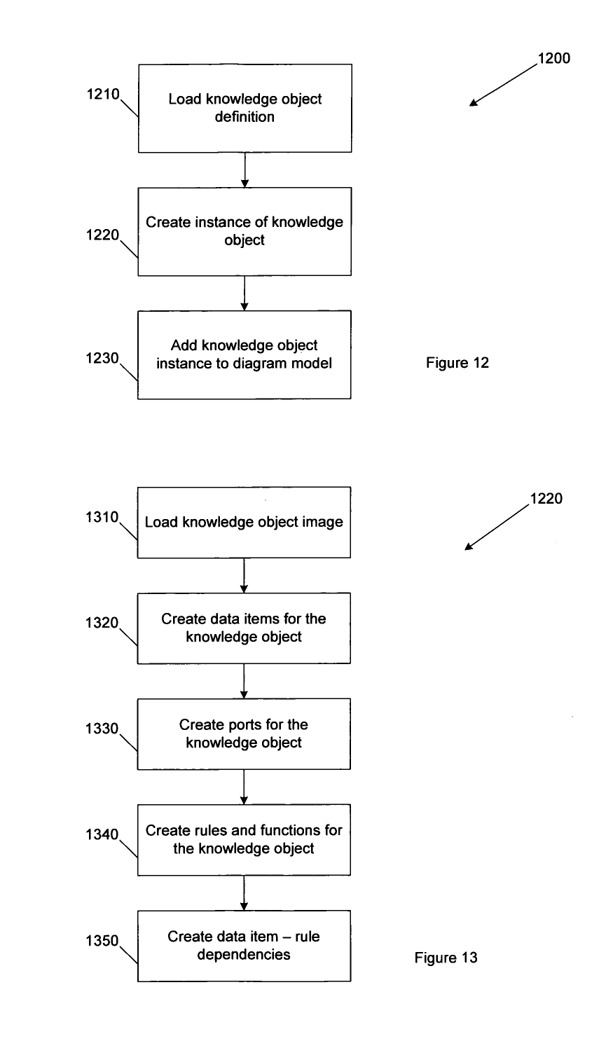

Referring now to FIG. 12, a method 1200 of creating a knowledge object model is described in further detail. The knowledge object definitions 370 are downloaded with the program. Method 1200 begins at step 1210, at which knowledge object creation module 255 instantiates a knowledge object definition 370 from central data model 240 in response to user selection of a particular knowledge object icon shown in section 915, for example, by dropping the icon onto viewport 905. At step 1220, KO creation module 255 then creates an instance of the selected kind of knowledge object based on the applicable knowledge objection definition 370. Step 1220 is described in further detail below, with reference to FIG. 13. Upon creation of the instance of the knowledge object model 500, it is then added to the diagram model 340.

Referring now to FIG. 13, a process of creating an instance of a knowledge object according to step 1220 is described in further detail. At step 1310, KO creation module 255 creates an image 520 in the user interface 215 according to the relevant knowledge object definition 370 by accessing and downloading the image 480 referenced by the link to the graphical representation 420 via the network 120. At step 1320, KO creation module 255 iterates through the list of data item definitions 430 to generate a list of data items 530. At this point, each data item 530 comprises a variable with an identifier and a place holder for a value.

At step 1330, KO creation module 255 creates a list of ports 550 based on the port definitions 450. Each port 550 has a standard connection type identifier, a type of transmission method, being either input, output or input/output, and a connection method of either “proximity”, “connected”, “container” or “global”, as described below. A port 550 also has a series of references to data items of the KObject that it will transmit to on changes and apply changes upon receiving new input via a connection.

At step 1340, KO creation module 255 generates a list of behaviours 540 based on the behaviour definitions 440. Each behaviour 540 is instantiated into either a mathematical function with references to data items in the knowledge object or a logical rule with references to data items. At step 1350, KO creation module 255 creates the dependencies between the created behaviours 540, including rules and functions, and the data items 530. At step 1350, KO creation module 255 also adds a reference in the client system memory 220 to execute the relevant rule upon a change being made to the data item that is referenced by the behaviour 540.

Referring now to FIG. 14, a method 1400 of creating a connector model 345, representing a connection between two knowledge objects, is described in further detail. Creation of connector models 345 is performed by KO creation module 255. Two knowledge objects can be interconnected under the conditions of the two objects being manually selected to be interconnected through the user interface 215 by the user, which results in a ‘connected’ type of connection. Alternatively, at step 1410, two knowledge objects being placed in enough visual proximity, as defined by parameters of the relevant ports of the objects, can result in a ‘proximity’ connection being established.

A ‘proximity’ connection may be established where the port types are compatible and the graphical distance is less than a threshold distance. The threshold distance may be fixed or may be dynamically calculated. A dynamic threshold distance may depend on factors such as the size of the viewport 905, the types of knowledge objects, etc.

Additionally, one knowledge object being visually placed on top of another knowledge object can result in a ‘container’ connection being established. A container connection type will be created when the two objects in concern have compatible ports that have their type defined as “container” and the objects graphically overlap each other. A graphical representation 960 may not be displayed for this type of connection.

A ‘global’ connection is created when any pair of knowledge objects that have been added to a diagram model 340 have compatible ports that are of type “global”. This connection is created automatically between every pair of objects that is port-wise compatible in the diagram model 340. A graphical connection indicator 960 may not be displayed for this type of connection.

Any of the above connection types being established will result in step 1420 being completed and a new connection model 800 being created by KO creation module 255 according to an appropriate connector definition 375. At step 1430, the connection validator 830 compares the two knowledge objects and iterates through the ports that are available on both objects to check if the connection protocol type is compatible on both ports.

Regardless of connection type, all connections operate as a means for transferring data item updates between knowledge objects. The connection types are only considered in the event of creating a connection model and removing a connection model between two knowledge objects. For connections that are of “proximity” type, when the two objects are moved away from each other so that the graphical distance between them exceeds the threshold distance defined in the two ports of the knowledge objects, the connection is automatically removed. For connections of “container” type, when the knowledge object on top is moved and the two objects are no longer overlapping, the connection is automatically removed.

If no matching ports are found at step 1435, the connection model 800 is removed and deleted from memory at step 1440. On finding a pair of ports that is compatible in their protocols, the connection validator 830 also compares the transmission types of the ports at step 1450 to ensure that data can flow either uni-directionally or bi-directionally between the ports. At step 1450, the connection validator 830 accesses the list of connector definitions 375 in central data model 240, and searches for connections that match the protocols of the chosen two ports of the two knowledge objects. If no matching connection is found at step 1460, then at step 1470, the connection is created but a warning of the possible invalid connection is displayed in relation to a graphical representation 960 of the connection in viewport 905.

Upon finding a matching connection, at step 1460, the connection validator 830 iterates through the data item references on the chosen ports and sets up a communication channel between the ports at step 1480 so that updates to the data items on either port will flow to the other as defined by the transmission type (input, output, input/output) of the port. At step 1490, the KO creation module 255 adds the created connector model 800 to the diagram model 340 and a representation of the newly created connector is displayed in view port 905.

Referring now to FIG. 15, a process according to step 1140 of automatically validating a change to the system model is described in further detail. When a change to the diagram model or a knowledge object is made, the change is input to the relevant diagram model 340 in step 1505 to determine the nature of the change and in 1510 evaluates if the change has resulted in any data items being updated. If data items were updated, the knowledge objects 350 that are affected by the change are identified at step 1515. Relevant behaviours 540 are identified in step 1520 for each affected knowledge object. Each of those identified behaviours is executed by each knowledge object in step 1525. As a behaviour may result in an update of one or more data items, such occurrences are checked in 1530, and if so, those data items are updated at step 1540 as required. This will in turn trigger another round of execution of the same steps starting from step 1520. If no other data items are affected, the process proceeds to step 1150.

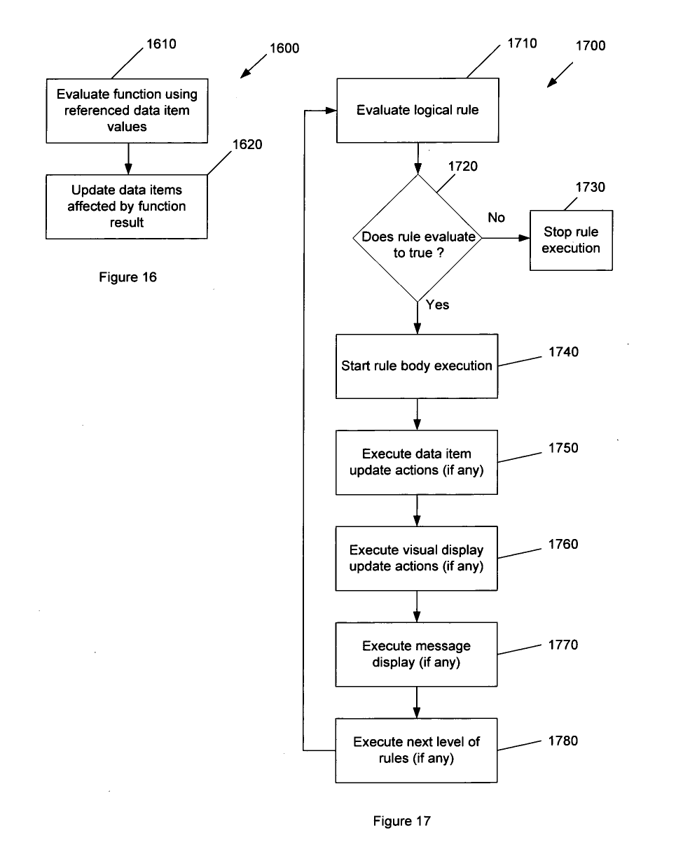

Referring now to FIG. 16, a method 1600 of executing a function as part of the validation process of step 1140 is described in further detail. A function is a mathematical expression using standard numerical operators, such as plus, minus, multiply, sine, cosine, log, differentiation, integration, etc. Such a function may also contain references to data items with numerical values. In step 1610, the relevant behaviour 540 replaces such references to data items of the knowledge object with the values of the referenced data items and then evaluates the mathematical function based on those new numerical values. The result may be applied to a pre-specified data item, and is executed as such in step 1620.

Referring now to FIG. 17, a method 1700 of executing a rule as part of a validation process according to step 1140 is described in further detail. A rule is a logical behaviour as contained in the behaviours 540 of a knowledge object model 350. Each rule consists of two values for comparison and a logical comparison operator that may include: equals, not equal, greater than or smaller than. The two values may include references to data items of the knowledge object the behaviour 540 belongs to. In step 1710, the behaviour 540 initially replaces any references to data items in the rule with the present values of the data items. Upon evaluating the condition at step 1720, if the condition evaluates to false, the rule execution is stopped in step 1730. If the rule evaluates to true, the body of the rule is executed starting from step 1740. If the rule body contains requests to update data item values, they are executed in step 1750. Any instructions within the rule body to update visual display of the knowledge object in concern is executed in step 1760 and the result is displayed through the user interface 215. The rule body may also contain instructions to display a text message on or near the graphical representation of the knowledge object via the user interface 215. This is executed in step 1770. If the rule body contains any more child rules, they are executed in step 1780, which triggers another nested process that will execute similarly for the child rule from step 1710.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-20. (canceled)

21. A method of modeling a system, the method comprising:
receiving, via an interface, input to create or load a model of the system;
receiving via the interface further input in relation to the system model;
determining whether the further input results in a change to the system model; and
if the further input is determined to change the system model, automatically providing feedback via the interface, the feedback being in relation to the changed system model.

22. The method of claim 21, wherein the system model comprises at least one object model representing a component of the system, wherein the at least one object model comprises a plurality of properties including at least one data item, at least one connection port and at least one behavior.

23. The method of claim 22, wherein the at least one behavior comprises at least one of a rule and a function.

24. The method of claim 21, further comprising, if the further input is determined to change the system model, automatically validating the changed system model.

25. The method of claim 24, wherein the validating comprises determining whether the change to the system model causes a problem within the system model and, if the change is determined to cause a problem, providing an indication of the problem via the interface.

26. The method of claim 25, wherein determining whether the change causes a problem comprises determining whether the change results in inconsistencies among properties of the at least one object model.

27. The method of claim 24, wherein the validating comprises:
determining at least one data item and at least one behavior affected by the change; and
executing each rule or function of the at least one behavior In relation to a respective one of the at least one data item.

28. The method of claim 27, wherein the validating further comprises:
determining whether at least one dependant data item of the at least one object model is affected by the change, each at least one dependant data item being dependant on one of the at least one data item;
determining at least one behavior that references the at least one dependant data item; and
executing each rule or function of the at least one behavior that references the at least one dependant data item.

29. The method of claim 21, wherein the system model further comprises at least one connector model, each connector model representing a connection between two object models.

30. The method of claim 21, wherein the interface comprises a diagram editor application and a diagram of the system model is displayed in a window of the diagram editor application.

31. The method of 21, further comprising displaying a diagram of the system model, wherein the diagram comprises graphical representations of any object models and connector models comprised in the system model.

32. The method of claim 31, further comprising:
determining whether graphical representations of object models of compatible types are sufficiently graphically proximate within the diagram to establish a connection between the object models;
determining whether the connection can be established between the object models based on properties of each of the object models; and
establishing the connection if it is determined that the connection can be established.

33. The method of claim 32, further comprising adding a connector model to the system model for the established connection.

34. A method of enabling modeling of a system, the method comprising:
receiving a serve request at a server system;
transmitting program code to an originator of the serve request, the program code being executable by at least one processing device to cause the at least one processing device to perform a method comprising,
receiving, via an interface, input to create or load a model of the system,
receiving via the interface further input in relation to the system model,
determining whether the further input results in a change to the system model, and
if the further input is determined to change the system model, automatically providing feedback via the interface, the feedback being in relation to the changed system model; and
authenticating the originator of the serve request for use of the program code.

35. The method of claim 34, further comprising receiving a save request from the originator of the serve request, the save request being in respect of a system model, and storing the system model in data storage accessible to the server system in response to the save request.

36. The method of claim 34, wherein the transmitting is performed using a cryptographically secure transmission protocol.

37. The method of claim 34, wherein the transmitted program code is encrypted and, if the originator is successfully authenticated, the server system transmits information to the originator to enable at least partial decryption of the program code.

38. A modeling system for modeling a system, the modeling system comprising:
an interface;
at least one processing device in communication with the interface; and
stored program code accessible to the processing device, the stored program code when executed by the at least one processing device causing the at least one processing device to perform a method comprising,
receiving, via an interface, input to create or load a model of the system,
receiving via the interface further input in relation to the system model,
determining whether the further input results in a change to the system model, and
if the further input is determined to change the system model, automatically providing feedback via the interface, the feedback being in relation to the changed system model.

39. A server system for enabling modeling of a system, the server system comprising:
at least one processor; and
data storage accessible to the at least one processor and storing program code executable by the at least one processor to cause the at least one processor to perform a method comprising:
receiving, via an interface, input to create or load a model of the system,
receiving via the interface further input in relation to the system model,
determining whether the further input results in a change to the system model, and
if the further input is determined to change the system model, automatically providing feedback via the interface, the feedback being in relation to the changed system model.

40. A non-transitory computer readable storage storing program code which, when executed by at least one processing device, causes the at least one processing device to perform a method comprising:
receiving, via an interface, input to create or load a model of the system;
receiving via the interface further input in relation to the system model;
determining whether the further input results in a change to the system model; and
if the further input is determined to change the system model, automatically providing feedback via the interface, the feedback being in relation to the changed system model.
